(19) United States
(12) Patent Application Publication
(10) Pub. No.: US 2021/0221074 A1
(43) Pub. Date: Jul. 22, 2021

(54) COMPRESSION MOLDING HOLLOW STRUCTURE

(71) Applicants: Magna Exteriors Inc., Concord (CA); Centre Technologique En Aérospatiale C.T.A., Saint-Hubert (CA)

(72) Inventors: Henry E. Moore, Guelph (CA); Ranjit Pachha, Brampton (CA); Joseph J. Laux, Ermatingen (CH); John A. Ingram, Richmond Hill (CA); Bruno Croteau-Labouly, Montréal (CA); Carl Ouellet, Boucherville (CA); Alexandre Chagnon, St-Jean-sur-Richelieu (CA); Robin Dubé, Montréal (CA)

(73) Assignees: Magna Exteriors Inc., Concord, ON (CA); Centre Technologique En Aérospatiale C.T.A., Saint-Hubert, QC (CA)

(21) Appl. No.: 15/734,361

(22) PCT Filed: Jun. 14, 2019
(86) PCT No.: PCT/IB2019/055007

§ 371 Date: Dec. 2, 2020

Related U.S. Application Data
(60) Provisional application No. 62/685,054, filed on Jun. 14, 2018.

(51) Int. Cl. B29C 70/48; B29C 33/52; B29C 43/02; B29C 43/50

(52) U.S. Cl. CPC B29C 70/48; B29C 33/52; B29K 2101/12; B29C 43/50; B29C 2043/5007; B29C 43/02

(57) ABSTRACT

A process for molding a hollow structure comprising the steps of: a. Forming a mandrel in a shape of a proposed cavity from a water-soluble substance capable of withstanding temperatures and pressures from a predetermined compression molding process; b. Positioning the mandrel in a suitable mold for forming an article which includes the mandrel within the article; and, c. Removing the mandrel by loosening and dissolving the mandrel with a water solution, thereby creating a cavity in the article.

### CROSS-REFERENCE TO RELATED APPLICATIONS

This application claims the benefit of U.S. Provisional Application No. 62/685,054, filed Jun. 14, 2018. The disclosures of the above application are incorporated herein by reference.

### FIELD OF THE INVENTION

The present invention relates to a compression molding hollow composite structure using a removable core.

### BACKGROUND OF THE INVENTION

It is desirable in the art to be able to mold and thermoform parts with inner cavities. This provides lighter, stiffer and stronger parts for use in the automotive and other industries. Because of the complexity of part designs and the temperatures and pressures at which parts are molded, it is hard to produce a one-piece part which includes a properly dimensioned cavity. Therefore, in many part designs a two piece construction is required where two formed parts are joined together with adhesive or other techniques to form a part with a cavity. This requires extra manufacturing steps.

Currently, in order to compression mold a hollow structure, inner and outer surface or the two half structures are molded separately and then joined together using structural adhesive. This requires separate tools and also press. The process is also time consuming with additional labor required for joining the outer and inner surface.

Mitsubishi Rayon Company has developed a removable particle core compression molding technology. This technology involves preparing a hollow plastic shell by blow molding. Ceramic particles are added to the hollow plastic shell. The ceramic particles are compressed using a plunger during compression molding. The ceramic particles can be removed after the molding, but the plastic shell remains in the part. In this case the thermoplastic blow molded hollow structure can deform at high temperature and pressure. This method also includes difficulties in making thin hollow structure, as the thermoplastic hollow structure can lose its stiffness if the thickness is too small. Also, in this method, the thermoplastic cavity becomes part of the structure and will either increase the weight or reduce the wall thickness of the composite structure. This method also is undesirable due to the use of a complicated tool i.e. an additional feature has to be built into the tool to get access for a plunger to build inner pressure for the ceramic particles.

Thus, when using bladder molding only low pressure can be applied using this technique. Complex geometry is not possible using bladder molding as it is difficult to insert and remove the bladder from the part. The pressures that current bladders can withstand, for extended life cycles, are too low and are not suitable for high pressure mass production compression molding.

For molding hollow structure with RTM or hand lay-up techniques, there are articles in which several types of cores are reported being used. Cores are used in the art which are made using aggregate like sand or microspheres which are bonded together either separately or in combination with sodium silicate, Polyvinyl alcohol or Polypyrolidone (PVP) with water. These are not advantageous since Sodium silicate is highly hygroscopic and can absorb moisture which can damage the core during storage. Polyvinyl Alcohol and Poylpyrolidone are water soluble polymers which cannot be used for compression molding at high temperature and pressure. Moreover, removal of the core using these polymers is difficult and would need an additional process like mechanical vibration or chemical treatment, which is not conducive for large scale manufacturing of parts. Also, the disposal of core material consisting of polymeric aggregate is not environmentally friendly. The manufacturing of a core using sand, sodium silicate PVA/PVP and water requires longer processing times to drive off the water from the final core. Such cores are believed to be limited to use in RTM molding, these types of cores are not known to be used for compression molding processes.

Other types of cores, which have been used in the past are also not suitable for withstanding high pressure molding conditions. For instance, other types of cores include: Honey comb-Nomex cores which are unable to withstand high pressure; fabric core-Coremat and Spheretex cores filled with hollow spheres are also unable to withstand high pressure molding conditions; foam cores made from—PVC, PET, Polyurethane, or Polystyrene are also unable to withstand high pressure and temperature, and wood-balsa or plywood cores are too heavy and hard to remove. Syntactic cores can withstand high pressures but are way too heavy which defeats the purpose of hollow molding structure.

In this case the thermoplastic blow molded hollow structure can deform at high temperature and pressure. This method also includes difficulties in making thin hollow structure, as the thermoplastic hollow structure can lose its stiffness if the thickness is too small. Also, in this method, the thermoplastic cavity becomes part of the structure and will either increase the weight or reduce the wall thickness of the composite structure. This method also is undesirable due to the use of a complicated tool i.e. an additional feature has to be built into the tool to get access for a plunger to build inner pressure for the ceramic particles.

The Mitsubishi Particle core technology uses a thermoplastic shell. This thermoplastic shell limits the temperature at which the Part can be compression molded.

Another core manufacturing attempt was made of aggregate like sand and binder consisting of either PVA, PVP or sodium silicate. The removal of these cores is difficult in a complex geometry like a curved or bent structure where direct high-pressure water is unable to reach. To remove these cores, heated water, steam, mechanical vibration or chemical treatment is required. All these techniques will impact the performance of the molded composite part.

Therefore, it is a goal in the art to provide an improved process for providing a cavity in a finished part without the drawbacks set forth above. It is a goal in the present invention to mold inner and outer surface of an Automotive OEM part using removable core eliminating the need to join outer and inner with adhesive.

### SUMMARY OF THE INVENTION

The present invention includes a process for molding a hollow structure using a removable mandrel core. In the process of the present invention, a mandrel is formed in a shape of a predesigned cavity from a water-soluble substance capable of withstanding temperatures and pressures from a predetermined molding process. The mandrel is then positioned in a suitable mold for forming an article which includes the mandrel within the article. Thereafter the cavity is formed by removing the soluble mandrel by loosening and dissolving the mandrel with a water solution, which creates a cavity in the article.

Therefore, in order to resolve the above difficulties, it was a goal to use a core that was easily manufactured and shaped, water soluble, easily removable and environmentally friendly to use and can be tailored and adjusted depending on the parameters of the application. Also, the core formulation can be fine-tuned as required to meet the complexity of the part, molding parameters and ease of removal. Objectives of the present invention include: 1) Compression molding of composite hollow composite structure in one shot. 2) Compression molding of fiber reinforced composite under high pressure and temperature. 3) Low cost removable core for complex geometries. 4) Ease of removal of core material after molding process is a simple process like high pressure water washing and/or ultrasonic bath. 5) No chemicals or polymers to be used in core so that the core can be easily disposed of without environmental concern. 6) Limited complexity in the making of core, molding hollow structure and removal of core process for large scale production. 7) Adjustable additive proportions to tailor the core properties so that the core can be easily removed by water pressure. 8) Mandrel comprised of variable sections, a combination of a re-usable mandrel and water-soluble mandrel. 9) Improved surface of internal cavity by a painted mandrel to fill surface porosity and ease core removal. 10) Thin section cores that can go down to ¼ inch. 11) Variable cross-section cores of any shape, including rectangle, omega, trapezoidal. 12) Variable core thickness to enable variable cavity thickness. 13) Local core thickness reductions to enable locally thickened parts for mechanical fastening purposes.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1A-1H are illustrative views of the process of the present invention;

FIG. 2 is a perspective view showing the mandrel core molded into shape in a mold;

FIG. 3 is a perspective view of the core of FIG. 2 out of the mold;

FIG. 4 is a perspective view of the core being placed on a first sheet of sheet molding composition in preparation for compression molding;

FIG. 5 is a side view of the mandrel core and SMC assembly ready for compression molding;

FIG. 6 is a perspective view of the mandrel core and SMC assembly being placed in a compression mold;

FIG. 7 is a view of the completed molded part with mandrel core before removing the core with water; and,

FIG. 8 is a sectional view of the part of FIG. 7 which is cut for inspection.

### DETAILED DESCRIPTION OF THE PREFERRED EMBODIMENTS

The following description of the preferred embodiment(s) is merely exemplary in nature and is in no way intended to limit the invention, its application, or uses.

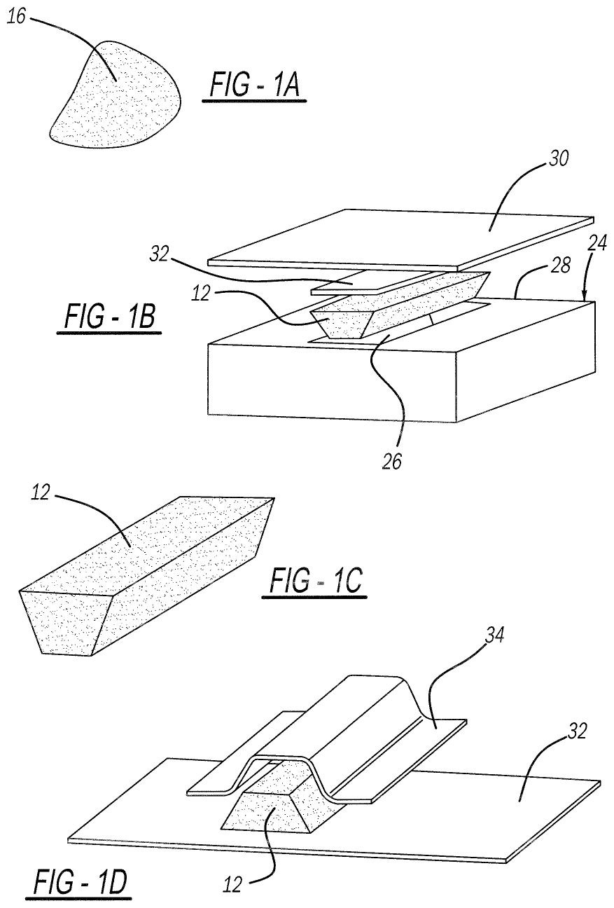

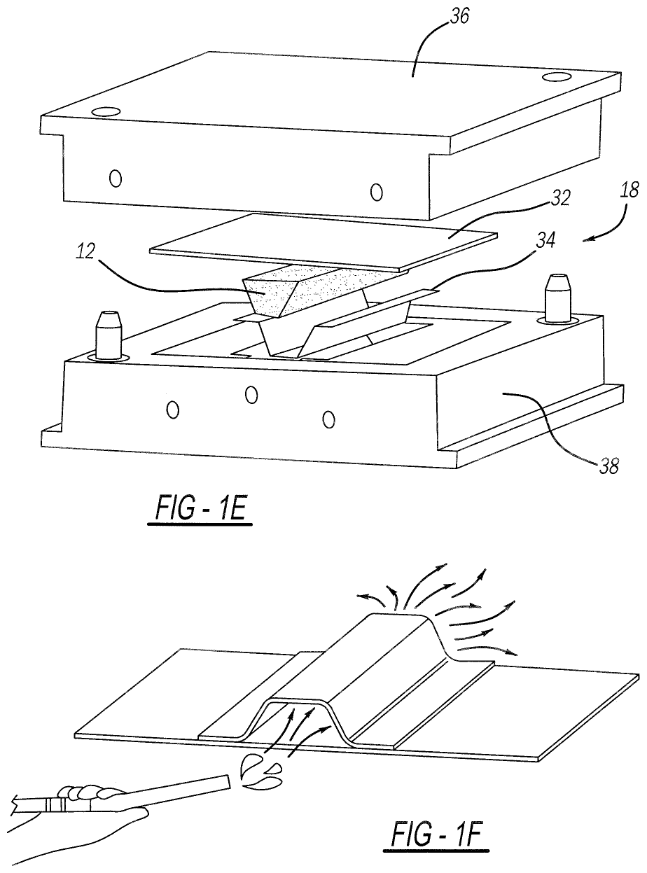

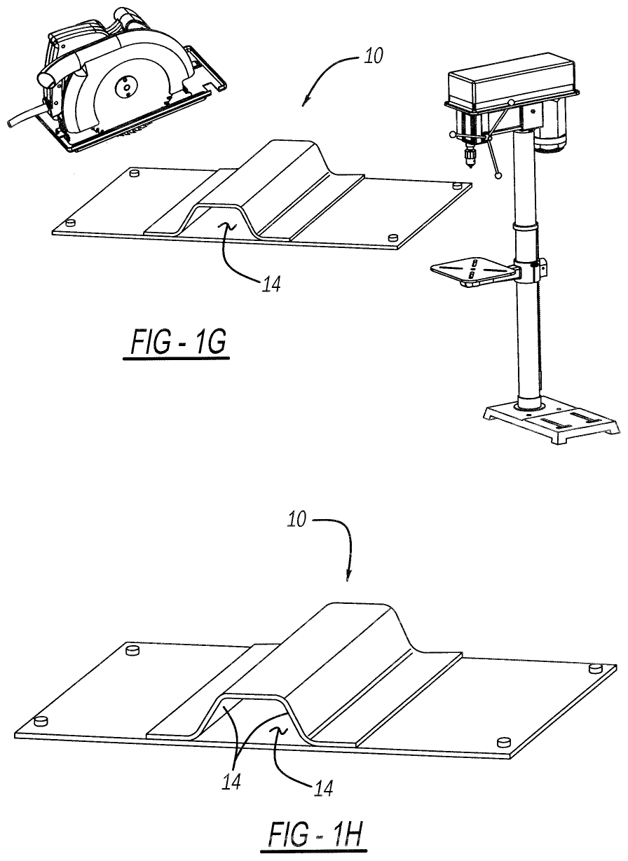

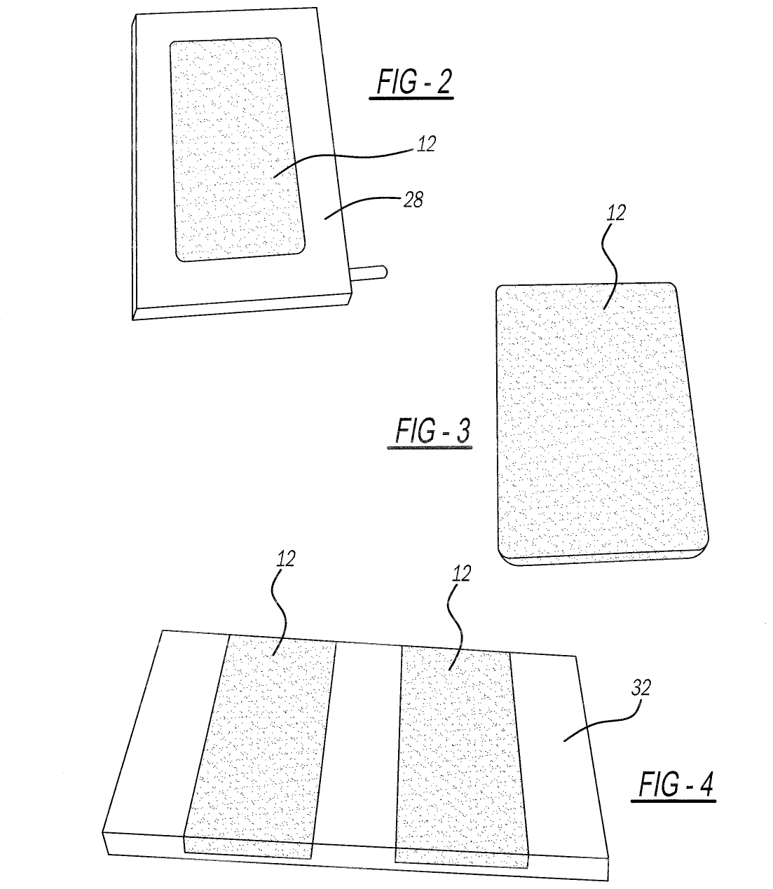

Referring now to the drawings and specifically to FIG. 1, the present invention includes a process for molding a hollow structure 10 using a removable mandrel core 12. In the process of the present invention, a mandrel is formed in a shape of a predesigned cavity 14 from a water-soluble substance 16 (in the present embodiment a salt and sugar mix) capable of withstanding temperatures and pressures from a predetermined molding process 18. The mandrel 12 is then positioned in a suitable mold 18 for forming an article 20 which includes the mandrel 12 within the article 20. Thereafter, the cavity 14 is formed by removing the mandrel by loosening and dissolving the mandrel with a water solution 22, which creates a cavity 14 in the article 20.

As examples and as set forth above, the mandrel/core 12 is formed from a salt and sugar solution in the form of the final cavity desired in the part. In a preferred embodiment, the mandrel 12 is formed from a solution of salt and sugar. In a preferred embodiment mixture of from about 3% to about 25% by weight sugar is mixed with from about 97% to about 75% by weight salt (containing a periodic table Group 1A metal, such as sodium combined with a Group 7A halogen such as chloride, with preferred salts being sodium chloride, potassium chloride, sodium bromide, potassium bromide and mixtures thereof). The sugars used can be saccharose, maltose, trehalose or starch or a mixture of them. As shown in the drawings the mandrel is formed in the shape of the cavity 14 by way of a mold 24 which has a forming cavity 26 in a lower platen 28 and an upper platen 30 with a mold insert 32. Thereafter a compression mold is used to form a hardened mandrel core 12 by heating the mold containing the salt and sugar mixture at a temperature between 120 and 180° C. and a pressure between generally about 200 to about 5000 psi, typically from about 600 to about 3400 psi and preferably from about 1200 to about 2400 psi until cured. Typical curing times are between 1 and 30 minutes depending on the mixture pressures and temperatures used. Suitable cavities are found to be formed in molded parts.

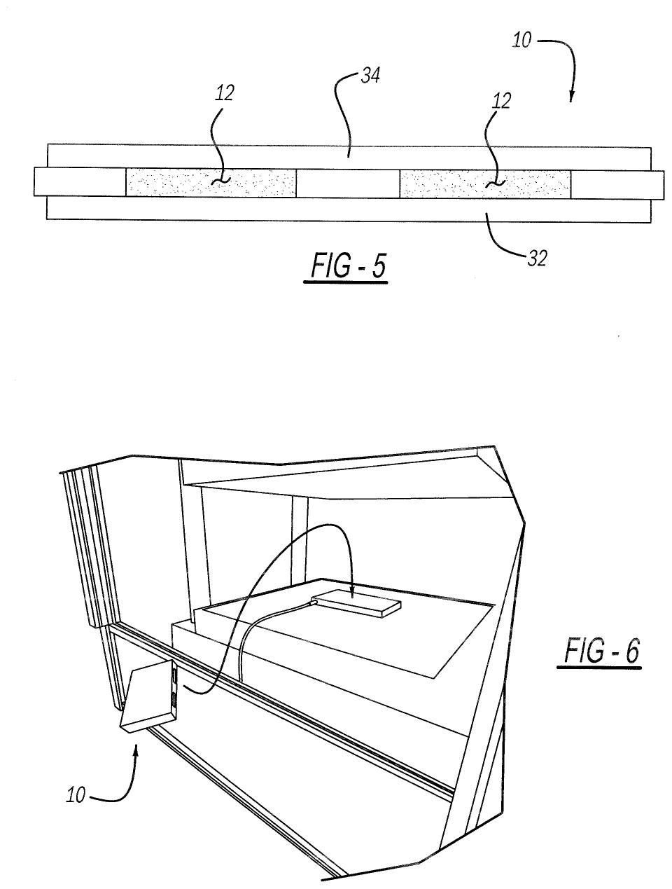

It will be readily appreciated by those skilled in the art that the process for molding a part of the present invention can be used and is readily adaptable with RTM, filament winding, pultrusion, wet press molding and thermoplastic injection and compression molding. For purposes of illustration, the process disclosed herein as an example is sheet molding compound compression molding. After a suitable mandrel/core is formed from the salt and sugar mixture, it is placed between at least a lower SMC sheet 32 and an upper sheet 34. As shown in FIG. 4, several layers of SC are typically used to form a proper sandwiched layered construction for forming of the part via compression molding.

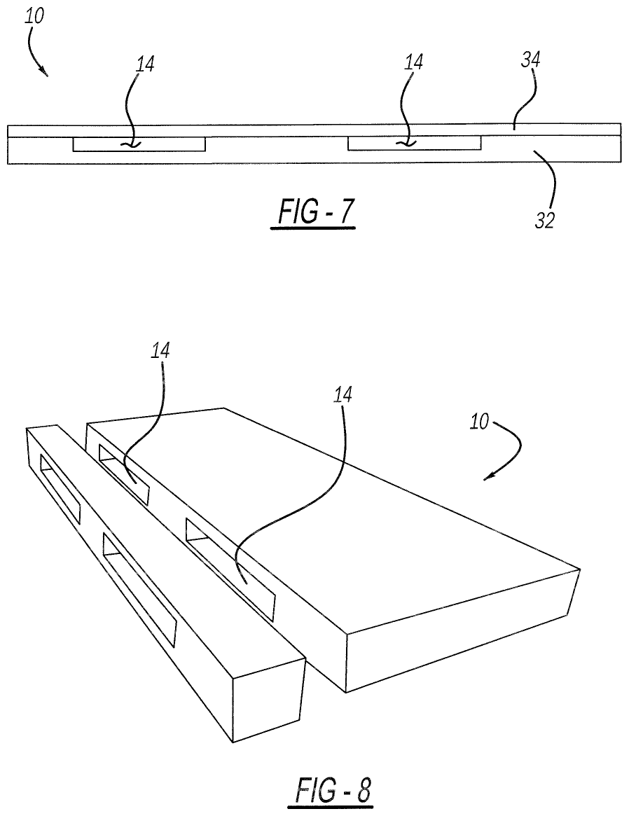

A compression molding machine 18 with upper 36 and lower 38 platens for forming the final part under heat and compression. It has been found that the part and mandrel assembly of the present invention can withstand heat of up to about 150° C. and up to a pressure of 1300 psi (pounds per square inch) during this molding process. It is to be appreciated that different resin systems used for molding of parts may withstand higher pressures. The Mandrel itself can withstand higher pressure, therefore, typically the material used for compression molding limits the amount of pressure used. Thus, parts with a different resin system may allow higher compression and temperature. The sandwiched structure is heated under pressure for forming a one-piece part shown in FIGS. 7 and 8.

Thereafter, the part is cooled and hot water and/or pressurized water and/or an ultrasonic bath is used for removal of the mandrel/core 12. And the part is completed by machining, drilling or shaping and the like.

In some applications if the part geometry allows it a reusable core portion (such as made of a Teflon (PTFE) material) mandrel may be used in combination with the mandrel described above. In such situations the Teflon portion of the mandrel must be situated at a portion of the mold which allows removability of the Teflon core prior to removal by water or the like of the water soluble portion of the core. In such a case the Teflon core is removed and reused with a new water soluble core if desired in a particular application.

The water-soluble core can be easily removed after molding and provides the possibilities of complex geometries for cavity formation. The process of the present invention provides fast cycle times which facilitates use in large scale manufacturing operations. The mandrel core is low cost and environmentally friendly and provides an incompressible core that does not require external plungers or other fixtures to exert pressure to maintain its shape during molding.

### Example

As examples and as set forth above, the mandrel/core 12 is formed from a salt and sugar solution in the form of the final cavity desired in the part. The mandrel 12 is formed from a solution of salt and sugar in mixtures of embodiment mixture of from about 3% to about 25% by weight sugar is mixed with from about 97% to about 75% by weight of salts (containing a periodic table Group 1A metal, such as sodium combined with a Group 7A halogen such as chloride, with preferred salts being sodium chloride, potassium chloride, sodium bromide, potassium bromide and mixtures thereof). The sugars used can be saccharose, maltose, trehalose or starch or a mixture of them. As shown in the drawings the mandrel is formed in the shape of the cavity 14 by way of a mold 24 which has a forming cavity 26 in a lower platen 28 and an upper platen 30 with a mold insert 32. Thereafter a compression mold is used to form a hardened mandrel 12 by heating the mold containing the salt and sugar mixture at a temperature between 120 and 180° C. and a pressure between generally about 200 to about 5000 psi, typically from about 600 to about 3400 psi and preferably from about 1200 to about 2400 psi until cured. Typical curing times are between 1 and 30 minutes depending on the mixture pressures and temperatures used. Suitable cavities are found to be formed in molded parts at temperatures up to 150 degrees centigrade and 1300 PSI.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. A process for molding a hollow structure comprising the steps of:
a. Forming a mandrel in a shape of a proposed cavity from a water-soluble substance capable of withstanding temperatures and pressures from a predetermined compression molding process;
b. Positioning the mandrel in a suitable mold for forming an article which includes the mandrel within the article; and,
c. Removing the mandrel by loosening and dissolving the mandrel with a water solution, thereby creating a cavity in the article.

2. The process of claim 1 wherein the mandrel is formed from a mixture of salt and sugar and shaped to the desired shape of the cavity.

3. The process of claim 2 wherein the mandrel is formed from a mixture of from about 3% to about 25% by weight sugar selected from the group of saccharose maltose, trehalose, starch and mixtures there of mixed with from about 97% to about 75% by weight of a salt comprising a Group 1A metal and a Group 7A halogen element.

4. The process of claim 2 wherein the mandrel is comprised of variable sections, a combination of a re-usable mandrel and water-soluble mandrel.

5. The process of claim 1 wherein sheet molding composition is used for the compression moldable sheets.

6. The process of claim 1 wherein a thermoplastic sheet is used for the compression moldable sheets.

7. The process of claim 1 wherein the molding process is selected from the group of RTM, filament winding, pultrusion, wet press molding and thermoplastic injection molding.

8. The process of claim 1 wherein the molding process is a compression molding process and the mandrel is positioned between two thermoformable or thermosetting sheets of material for forming a final cavity in the article.

9. The process of claim 2 wherein during molding of the part and mandrel withstands molding pressures of up to about 1300 psi and temperatures up to about 150° C.

10. The process of claim 1 wherein the mandrel core is molded to form the structure and is processed in a compression mold at a temperature up to 180° C. and 1400 psi pressure for hardening of the mandrel.

11. The process of claim 1 wherein hot water and/or pressurized water and/or an ultrasonic bath is used for removing of the mandrel core.

12. The process of claim 2 wherein the mandrel core is painted to provide an improved surface porosity for providing a smooth inner part surface after molding.

13. The process of claim 12 wherein the paint remains within the part after the manufacturing process.

14. The process of claim 2 wherein the mandrel core is manufactured in thin sections of greater than or equal to ¼ inch.

15. The process of claim 2 wherein the mandrel core is manufactured with variable cross-section of any predetermined shape.

16. The process of claim 2 wherein said predetermined shape is selected from the group consisting of rectangle, omega, trapezoidal and combinations thereof.

17. The process of claim 2 wherein the mandrel core is manufactured with predetermined variable thickness cross-sections to enable variable cavity thickness.

18. The process of claim 2 wherein the mandrel core is manufactured with local core thickness reductions to enable locally thickened parts in the final part to provide a thickened portion which is used for mechanical fastening purposes.

19. The process of claim 1 wherein the salt is selected from the group consisting of sodium chloride, potassium chloride, sodium bromide, potassium bromide and mixtures thereof.

20. A process for compression molding of a hollow structure comprising the steps of:
a. Forming a mandrel in a shape for forming a predetermined cavity a water-soluble substance comprising a mixture of sugar selected from the group of saccharose maltose, trehalose, starch and mixtures thereof and a group 1A metal and group 7A halogen containing salt material which is capable of withstanding temperatures of up to about 150° C. and pressures of up to about 3000 PSI compression molding process of from about;
b. Positioning the mandrel between layers of thermoformable or thermosetable material in a suitable mold for forming an article which includes the mandrel within the article and compression molding the part including the mandrel; and,
c. Removing the mandrel by loosening and dissolving the mandrel with a water solution, thereby creating a cavity in the article.

21. An article formed by the process of claim 20.

22. The process of claim 20 wherein the salt is selected from the group consisting of sodium chloride, potassium chloride, sodium bromide, potassium bromide and mixtures thereof

23. The process of claim 22 wherein the salt is Sodium Chloride.
